(19) United States
(12) Patent Application Publication
(10) Pub. No.: US 2012/0245763 A1
(43) Pub. Date: Sep. 27, 2012

(54) DRUNK DRIVING PREVENTION SYSTEM AND EXTERNAL SERVER USED FOR THE SAME

(75) Inventor: Mina Mizuno, Okazaki-shi (JP)

(73) Assignee: TOYOTA JIDOSHA KABUSHIKI KAISHA, Toyota-shi (JP)

(21) Appl. No.: 13/429,529

(22) Filed: Mar. 26, 2012

(30) Foreign Application Priority Data
Mar. 24, 2011 (JP) 2011-065903

(51) Int. Cl. G06F 7/00; G06G 7/70

(52) U.S. Cl. 701/2; 701/1; 701/101

(57) ABSTRACT

A drunk driving prevention system is equipped with an external server and an on-vehicle component. The on-vehicle component is equipped with a detection unit that detects an alcohol concentration of a driver, an acquisition unit that acquires information on a current position of a vehicle, and a communication unit that transmits to the external server the alcohol concentration as well as the current position information. The external server is equipped with a storage unit that stores a plurality of criteria that relate to an alcohol concentration falling under drunk driving and are different from one another as a result of geographical differences, a communication unit that receives the alcohol concentration and the current position information, and a determination unit that determines, based on that one of the criteria, whether the alcohol concentration received is an alcohol concentration falling under drunk driving.

### INCORPORATION BY REFERENCE

The disclosure of Japanese Patent Application No. 2011-065903 filed on Mar. 24, 2011 including the specification, drawings and abstract is incorporated herein by reference in its entirety.

### BACKGROUND OF THE INVENTION

1. Field of the Invention

The invention relates to a drunk driving prevention system that prevents drunk driving of a driver of a vehicle, and an external server used for the same.

2. Description of Related Art

For example, in Japanese Patent Application Publication No. 2008-152562 (JP-2008-152562 A), there is disclosed a vehicle driving restriction device that detects an alcohol concentration in an exhalation of a driver of a vehicle, and stops an engine of the vehicle to restrict the driving of the vehicle when the alcohol concentration is equal to or higher than a prescribed value. According to this device, the vehicle cannot be driven when the driver of the vehicle is drunk. Therefore, drunk driving of the vehicle is prevented, and safe driving thereof is realized.

By the way, the criteria on the alcohol concentration falling under drunk driving (the criterion that is prescribed according to a law, an ordinance or the like) may be different from one another as a result of geographical differences, such as differences among countries, regions, and states. If it is determined based on the same criterion or criteria without taking account of geographical differences, an incorrect determination may be made. For example, the latest criterion value is not reflected.

### SUMMARY OF THE INVENTION

The invention provides a drunk driving prevention system that, even when there are criteria that are different from one another as a result of geographical differences, can prevent drunk driving in consideration of the differences, and an external server that is used for the drunk driving prevention system.

A drunk driving prevention system according to a first aspect of the invention is equipped with an external server and an on-vehicle component. The on-vehicle component is equipped with a detection unit that detects an alcohol concentration in an exhalation of a driver of a vehicle, on which the on-vehicle component is mounted, an acquisition unit that acquires information on a current position of the vehicle, and an on-vehicle side communication unit that transmits to the external server the alcohol concentration detected as well as the information on the current position of the vehicle. The external server is equipped with a storage unit that stores a plurality of criteria that relate to an alcohol concentration falling under drunk driving and are different from one another as a result of geographical differences, an external server side communication unit that receives the alcohol concentration and the information on the current position of the vehicle, which are transmitted from the on-vehicle component, and a determination unit that determines, based on that one of the criteria in the storage unit which corresponds to the current position of the vehicle, whether the alcohol concentration received is the alcohol concentration falling under drunk driving.

A drunk driving prevention system according to a second aspect of the invention is equipped with an external server and an on-vehicle component. The on-vehicle component is equipped with a detection unit that detects an alcohol concentration in an exhalation of a driver of a vehicle, on which the on-vehicle component is mounted, an acquisition unit that acquires information on a current position of the vehicle, and an on-vehicle side transmission unit that transmits to the external server the information on the current position of the vehicle. The external server is equipped with a storage unit that stores a plurality of criteria that relate to an alcohol concentration falling under drunk driving and are different from one another as a result of geographical differences, a reception unit that receives the information on the current position of the vehicle, which is transmitted from the on-vehicle component, and an external server side transmission unit that transmits to the on-vehicle component that one of the criteria in the storage unit which corresponds to the current position of the vehicle. The on-vehicle component is further equipped with a determination unit that determines, based on the criterion transmitted from the external server, whether the alcohol concentration detected is the alcohol concentration falling under drunk driving.

An external server according to a third aspect of the invention is an external server that prevents drunk driving via communication with an on-vehicle component. The external server is equipped with a storage unit that stores a plurality of criteria that relate to an alcohol concentration falling under drunk driving and are different from one another as a result of geographical differences, a reception unit that receives from the on-vehicle component an alcohol concentration in an exhalation of a driver of a vehicle, on which the on-vehicle component is mounted, and information on a current position of the vehicle, a determination unit that determines, based on that one of the criteria in the storage unit which corresponds to the current position of the vehicle, whether the alcohol concentration received is the alcohol concentration falling under drunk driving, and a transmission unit that transmits to the on-vehicle component a driving stop command for restraining driving of the vehicle from being started or continued, when the determination unit makes an affirmative determination.

An external server according to a fourth aspect of the invention is an external server that prevents drunk driving via communication with an on-vehicle component. The external server is equipped with a storage unit that stores a plurality of criteria that relate to an alcohol concentration falling under drunk driving and are different from one another as a result of geographical differences, a reception unit that receives from the on-vehicle component information on a current position of a vehicle, on which the on-vehicle component is mounted, and a transmission unit that transmits to the on-vehicle component that one of the criteria in the storage unit which corresponds to the current position of the vehicle.

According to each of the foregoing aspects of the invention, a drunk driving prevention system that, even when there are criteria that are different from one another as a result of geographical differences, may prevent drunk driving in consideration of the differences, and an external server that is used for the drunk driving prevention system are obtained.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view showing the essential configuration of a drunk driving prevention system according to the first embodiment of the invention;

FIG. 2 is a flowchart showing an example of a control routine that is executed by an on-vehicle component of the first embodiment of the invention;

FIG. 3 is a flowchart showing an example of a control routine that is executed by an on-vehicle component of the second embodiment of the invention;

FIG. 4 is a flowchart showing an example of a control routine that is executed by an external server of the second embodiment of the invention;

FIG. 5 is a view showing the essential configuration of a drunk driving prevention system according to the third embodiment of the invention;

FIG. 6 is a flowchart showing an example of a control routine that is executed by an on-vehicle component of the third embodiment of the invention;

FIG. 7 is a flowchart showing an example of a control routine that is executed by an external server of the third embodiment of the invention; and

FIG. 8 is a flowchart showing an example of a control routine that is executed by an on-vehicle component of the fourth embodiment of the invention.

### DETAILED DESCRIPTION OF EMBODIMENTS

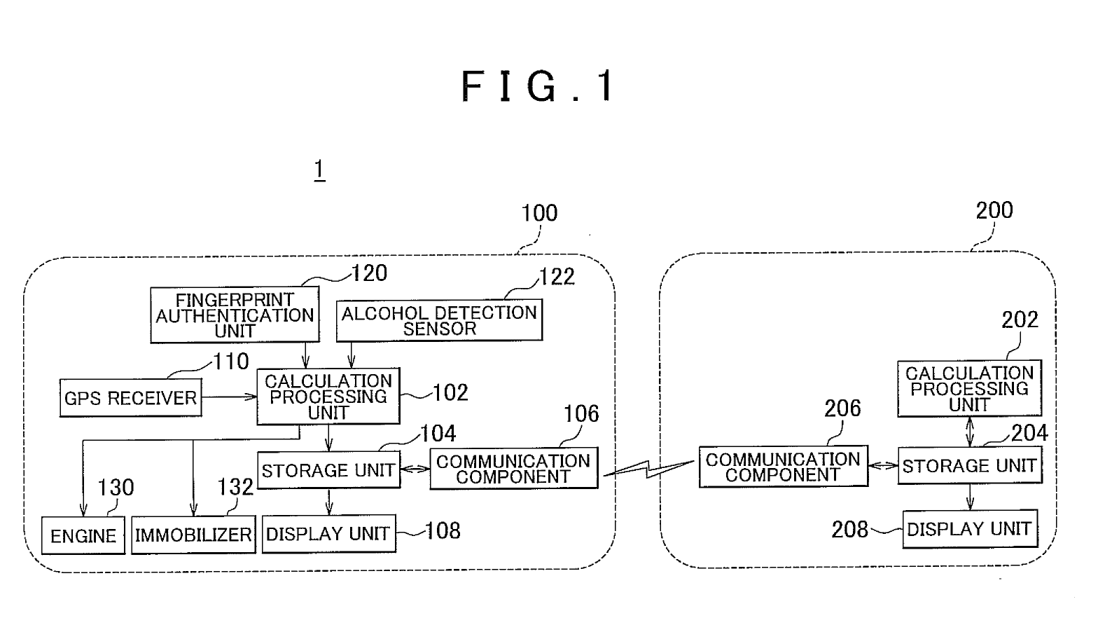

FIG. 1 is a view showing the essential configuration of a drunk driving prevention system 1 according to the first embodiment of the invention. The drunk driving prevention system 1 includes an on-vehicle component 100 mounted on a vehicle, and an external server 200 installed in an external center.

The on-vehicle component 100 may be mounted on each of a plurality of vehicles. The on-vehicle component 100 of a certain one of the vehicles will now be described. As shown in FIG. 1, the on-vehicle component 100 includes a calculation processing unit 102, a storage unit 104, a communication component 106, a display unit 108, a GPS receiver 110, a fingerprint authentication unit 120, an alcohol detection sensor 122, an engine 130, and an immobilizer 132.

The calculation processing unit 102 may be constituted by a CPU or the like. The storage unit 104 may be constituted by a plurality of storage devices including a work memory (a RAM) and the like. The calculation processing unit 102 and the storage unit 104 may be constituted by an ECU. Further, respective functions of the calculation processing unit 102, which will be described later, may be realized by a plurality of ECU's in a cooperative manner.

The display unit 108 may be a display, a meter, or the like that is provided in a vehicle interior.

The communication component 106 is configured to communicate with a communication component 206 of the external server 200 via a radio communication network.

The GPS receiver 110 positions the vehicle based on a signal from a GPS satellite, and supplies a positioning result to the calculation processing unit 102. The calculation processing unit 102 detects a current position of the vehicle based on the positioning result of the GPS receiver 110. The calculation processing unit 102 generates vehicle current position information indicating the current position of the vehicle, and stores it into the storage unit 104. The vehicle current position information as well as a later-described alcohol concentration and later-described driver identification information is transmitted to the external server 200 by the communication component 106. It should be noted that the GPS receiver 110 may adopt any positioning method, such as a single positioning method, an interference positioning method, or the like. In addition to the GPS receiver 110, a gyro sensor or a wheel speed sensor (not shown) may be utilized to detect the position of the vehicle. Further, the current vehicle position or the like, which is calculated by the GPS receiver 110, may be corrected using a map matching technology.

The fingerprint authentication unit 120 is preferably provided at a location where data on the fingerprint of a driver may be acquired. The fingerprint authentication unit 120 may be provided on, for example, a steering wheel. The fingerprint authentication unit 120 may acquire the latest data on the fingerprint of a driver on a predetermined cycle. This is because the driver may be replaced with another driver in between times. The fingerprint authentication unit 120 supplies the acquired data on the fingerprint of the driver to the calculation processing unit 102. The calculation processing unit 102 generates the driver identification information, which makes it possible to identify a driver, based on the data on the fingerprint of the driver, and stores the generated information into the storage unit 104. The driver identification information may be another piece of information corresponding to the fingerprint data (e.g., a user ID registered in advance, data on an extracted characteristic part of a fingerprint, or the like). The driver identification information as well as the information on the current position of the vehicle and a later-described alcohol concentration is transmitted to the external server 200 by the communication component 106.

The alcohol detection sensor 122 is disposed in the vicinity of a driver's seat to output a signal corresponding to an alcohol concentration in air. The calculation processing unit 102 detects an alcohol concentration in air in the vicinity of the driver's seat, namely, an alcohol concentration in an exhalation of the driver of the vehicle, based on an output signal of the alcohol detection sensor 122, and stores the detected alcohol concentration into the storage unit 104. By the same token, the calculation processing unit 102 may detect a latest alcohol concentration in an exhalation of a driver on a predetermined cycle. This is because the driver may be replaced with another driver in between times, or may drink alcohol during driving. The alcohol concentration as well as the driver identification information and the information on the current position of the vehicle is transmitted to the external server 200 by the communication component 106.

The engine 130 generates a power of the vehicle. The engine 130 may be endowed with a fuel supply suspension function. The operation of the engine 130 is controlled in accordance with a command signal from the calculation processing unit 102.

Upon being activated, the immobilizer 132 forms a state in which the engine 130 cannot be started. For example, when an ID received from a transmission portion of a portable key possessed by a user coincides with an ID registered on the vehicle side, the immobilizer 132 is deactivated to form a state in which the engine 130 can be started. The operation of the immobilizer 132 is controlled in accordance with a command signal from the calculation processing unit 102.

The external server 200 may be constituted by a single large server that is installed at a predetermined location, or a plurality of servers that are disposed in a scattered manner at a plurality of locations. As shown in FIG. 1, the external server 200 includes a calculation processing unit 202, a storage unit 204, the communication component 206, and a display unit 208.

The calculation processing unit 202 may be constituted by a CPU or the like. The detailed function of the calculation processing unit 202 will be described later.

The storage unit 204 may be constituted by a rewritable storage device such as a hard disk drive. The storage unit 204 may be constituted by a plurality of storage devices including a work memory (a RAM) and the like.

The storage unit 204 includes an area database. More specifically, the storage unit 204 stores a plurality of criteria that relate to drunk driving and are different from one another as a result of geographical differences. This is because the criteria that relate to drunk driving (e.g., an alcohol concentration falling under drunk driving) are different from one another as a result of geographical differences (or differences among decrees, ordinances and the like resulting therefrom). The criteria may be created based on a decree, an ordinance, a regulation or the like. Accordingly, the criteria may be created for each area where a decree, an ordinance or the like is enacted. Any area unit may be used as long as it represents geographical ranges with different criteria. For example, country, region, state or the like may be adopted as an area unit. Further, the area unit need not be uniform. For example, each fine region may be adopted as an area unit in a certain state, whereas the whole state may be adopted as an area unit in each of other states.

The criteria that relate to drunk driving typically contain criteria that relate to an alcohol concentration falling under drunk driving (an alcohol concentration in an exhalation, the same will hold true hereinafter) (e.g., the lowest alcohol concentration relating to drunk driving).

The area database may be updated on a timely basis when a decree, an ordinance, a regulation or the like is changed/amended, when the areas are changed, etc.

The display unit 208 may be constituted by any display device.

The communication component 206 is configured to communicate with the communication component 106 of the on-vehicle component 100 via a radio communication network.

Next, the main operation of the drunk driving prevention system 1 according to this embodiment of the invention will be described.

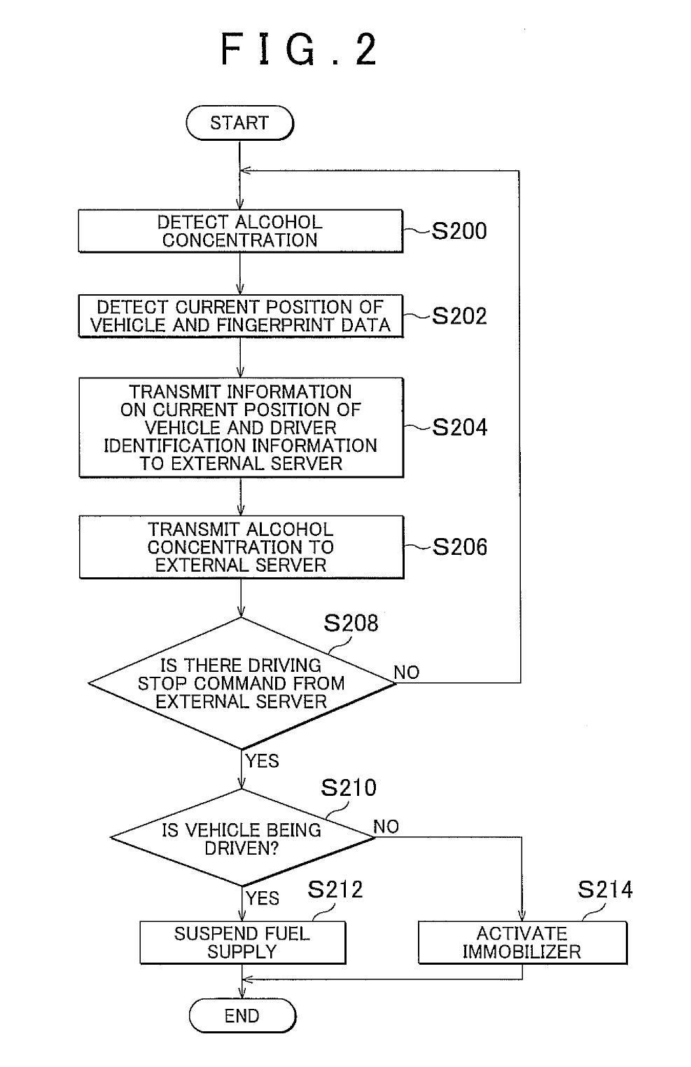

FIG. 2 shows an example of the operation by the on-vehicle component 100 in the first embodiment of the invention.

FIG. 2 is a flowchart showing an example of a control routine that is executed by the on-vehicle component 100 of this embodiment of the invention. A processing routine shown in FIG. 2 may be activated, for example, when a request is made to deactivate the immobilizer 132 (e.g., when the on-vehicle component 100 receives a response signal from a portable key or when a predetermined switch such as an engine switch is operated). After that, when the immobilizer 132 is deactivated and the engine 130 is started, the processing routine may be executed on a predetermined cycle until an ignition switch is turned off. Alternatively, the processing routine shown in FIG. 2 may be activated when the entrance of a user into the vehicle (which is detected, for example, from an on/off state of a door switch or by a load sensor embedded in a seat) is detected or when the driver grips the steering wheel (which is detected by, for example, a touch sensor or the like). After that, when driving is started, the processing routine may be executed on a predetermined cycle until the ignition switch is turned off.

In step 200 of FIG. 2, the calculation processing unit 102 detects an alcohol concentration in an exhalation of a current driver based on an output signal of the alcohol detection sensor 122.

In step 202, the GPS receiver 110 detects a current position of the vehicle, and the fingerprint authentication unit 120 detects data on the fingerprint of the current driver.

In step 204, the calculation processing unit 102 generates vehicle current position information and driver identification information based on information detected in the aforementioned step 202, and the communication component 106 transmits these pieces of information to the external server 200.

In step 206, the communication component 106 transmits an alcohol concentration detected by the calculation processing unit 102 in the aforementioned step 200 to the external server 200. At this moment, the alcohol concentration is transmitted in such a manner as to correspond to the vehicle current position information and the driver identification information. It should be noted that this processing may be performed simultaneously with the processing of the aforementioned step 204. That is, a single transmission signal containing these three pieces of information (the alcohol concentration, the vehicle current position information, and the driver identification information) may be generated. Further, this transmission signal may be transmitted to the external server 200 after other pieces of information are added to the transmission signal. For example, the transmission signal may be transmitted to the external server 200 after vehicle information for specifying a vehicle is added to the transmission signal, or the transmission signal may be transmitted to the external server 200 after information indicating whether the alcohol concentration was detected during the driving of the vehicle or prior to the driving of the vehicle (before the starting of the engine) is added to the transmission signal.

In step 208, the calculation processing unit 102 determines whether a driving stop command from the external server 200 has been received by the communication component 106 as a response to the transmission in the aforementioned step 206 from the external server 200. The driving stop command is a command that is transmitted from the external server 200 to prevent drunk driving. When the driving stop command from the external server 200 is received by the communication component 106, a transition to step 210 is made. When the driving stop command from the external server 200 is not received by the communication component 106 (or when a driving permission signal from the external server 200 is received by the communication component 106), a return to step 200 is made, and the processing starting from step 200 is performed again on a subsequent cycle.

In step 210, the calculation processing unit 102 determines, based on, for example, a state of the ignition switch, whether the vehicle is being driven. For example, when the ignition switch is in an OFF state, the calculation processing unit 102 may determine that the vehicle is not being driven. When the ignition switch is in a state other than the OFF state (an ON state or an ACC state), the calculation processing unit 102 may determine that the vehicle is being driven. Alternatively, it may be determined, based on vehicle speed data, a shift position, a throttle opening or the like, whether the vehicle is being driven. When the vehicle is being driven, a transition to step 212 is made. When the vehicle is not being driven, a transition to step 214 is made.

In step 212, the calculation processing unit 102 suspends the supply of fuel to the engine 130. Thus, when the current driving state falls under drunk driving, the vehicle can be safely stopped. Further, in step 212, the calculation processing unit 102 may cause the display unit 108 to display a warning.

In step 214, the calculation processing unit 102 activates the immobilizer 132 (does not permit deactivation thereof). Thus, drunk driving can be prevented beforehand by preventing the engine 130 from being started. Further, in step 214, the calculation processing unit 102 may cause the display unit 108 to display a warning.

The second embodiment of the invention is different from the foregoing first embodiment of the invention in one or some of the functions of the on-vehicle component 100 and the external server 200. More specifically, in the foregoing first embodiment of the invention, it is determined whether the alcohol concentration is equal to or higher than the criterion on the external server 200 side. In the second embodiment of the invention, however, it is determined whether the alcohol concentration is equal to or higher than the criterion on the on-vehicle component 100 side. The configuration itself of the second embodiment of the invention may be identical to the configuration of the first embodiment of the invention (see FIG. 1).

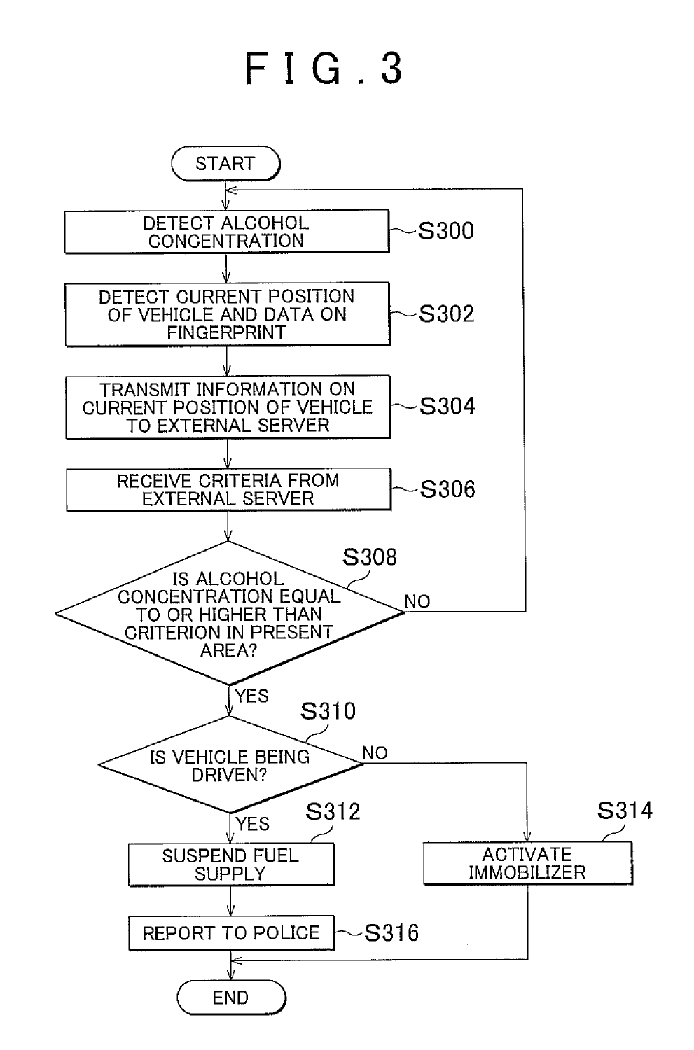

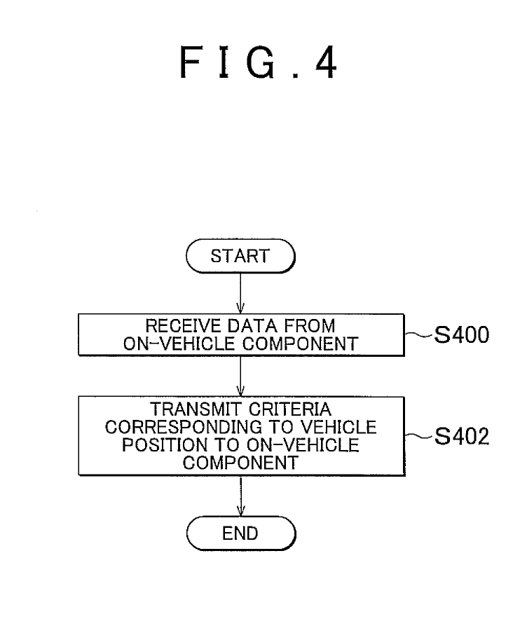

FIGS. 3 and 4 each show an example of the operation performed by the on-vehicle component 100 and the external server 200 in the second embodiment of the invention.

FIG. 3 is a flowchart showing an example of a control routine that is executed by the on-vehicle component 100 of this embodiment of the invention. The processing routine shown in FIG. 3 may be activated when a request to deactivate the immobilizer 132 is made. After that, when the immobilizer 132 is deactivated and the driving of the vehicle is started, the processing routine may be executed on a predetermined cycle until the ignition switch is turned off. Alternatively, the processing routine shown in FIG. 3 may be activated when the entrance of a user into the vehicle is detected or when a driver grips the steering wheel. After that, when the driving of the vehicle is started, the processing routine may be performed on a predetermined cycle until the ignition switch is turned off.

In step 300 of FIG. 3, the calculation processing unit 102 detects an alcohol concentration in an exhalation of a current driver based on an output signal of the alcohol detection sensor 122.

In step 302, the GPS receiver 110 detects a current position of the vehicle, and the fingerprint authentication unit 120 detects data on the fingerprint of the current driver.

In step 304, the calculation processing unit 102 generates the vehicle current position information based on the information detected in the aforementioned step 302, and the communication component 106 transmits the vehicle current position information to the external server 200. This transmission signal may contain a request for criteria.

In step 306, the communication component 106 receives criteria from the external server 200 as a response to the transmission in the aforementioned step 304 from the external server 200. The criteria may contain information indicating a criterion applied to an area to which the current position of the vehicle belongs.

In step 308, the calculation processing unit 102 determines, based on the criteria received in the aforementioned step 304, whether the alcohol concentration is an alcohol concentration falling under drunk driving in the area to which the current vehicle position belongs. When the detected alcohol concentration is equal to or higher than the criterion in the area to which the current vehicle position belongs, a transition to step 310 is made. On the other hand, when the detected alcohol concentration is lower than the criterion in the area to which the current vehicle position belongs, a return to step 300 is made. Thus, even in the case where the detected alcohol concentration is equal to or higher than a criterion in another area, when the detected alcohol concentration is lower than a criterion in the area to which the current vehicle position belongs, the later-described fuel supply suspension processing, the later-described reporting processing, or the like (see steps 312, 314 and 316) is not performed.

In step 310, the calculation processing unit 102 determines whether the vehicle is being driven. When the vehicle is being driven, a transition to step 312 is made. When the vehicle is not being driven, a transition to step 314 is made.

In step 312, the calculation processing unit 102 suspends the supply of fuel to the engine 130. Thus, when the current driving state falls under drunk driving, the vehicle can be safely stopped. When the processing of step 312 ends, a transition to step 316 is made. Alternatively, a transition to step 316 may be made while continuing to suspend the supply of fuel.

In step 314, the calculation processing unit 102 activates the immobilizer 132 (does not allow the immobilizer 132 to be deactivated). Thus, drunk driving can be prevented beforehand by preventing the engine 130 from being started.

In step 316, the calculation processing unit 102 reports to the police via the communication component 106. The reported contents may contain information indicating that the alcohol concentration is equal to or higher than the criterion, and the driver identification information. Further, the reported contents may further contain the received vehicle current position information.

FIG. 4 is a flowchart showing an example of a control routine that is executed by the external server 200 of this embodiment of the invention.

In step 400, the communication component 206 receives data from the communication component 106 on the vehicle side. These data are the vehicle current position information transmitted in step 304 of FIG. 3 as described above.

In step 402, the calculation processing unit 202 accesses the storage unit 204 to extract criteria corresponding to the current position of the vehicle based on the vehicle current position information received from the on-vehicle component 100, and transmits the extracted criteria to the on-vehicle component 100 (the on-vehicle component 100 to which the data received in the aforementioned step 400 have been transmitted) via the communication component 206.

The third embodiment of the invention is mainly different from the foregoing first embodiment of the invention in that the processing of reporting the driver identification information is not performed.

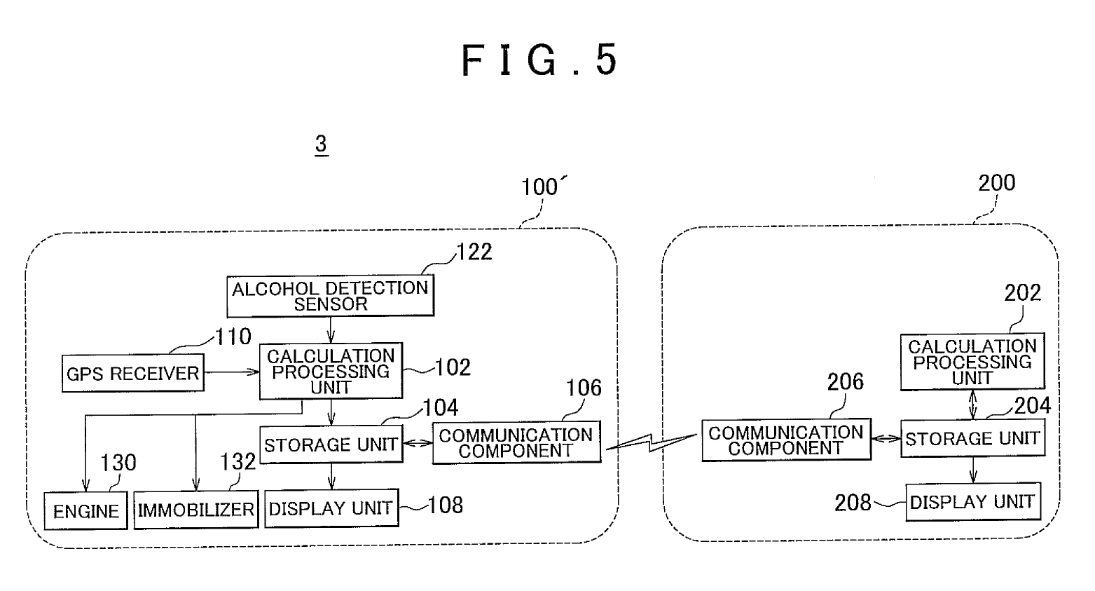

FIG. 5 is a view showing the essential configuration of a drunk driving prevention system 3 according to the third embodiment of the invention. The drunk driving prevention system 3 includes an on-vehicle component 100′ mounted on the vehicle, and the external server 200 installed in the external center.

The on-vehicle component 100′ may be identical in configuration to the on-vehicle component 100 according to the foregoing first embodiment of the invention except in that the fingerprint authentication unit 120 is not provided. The external server 200 may be identical in configuration to the external server 200 according to the foregoing first embodiment of the invention.

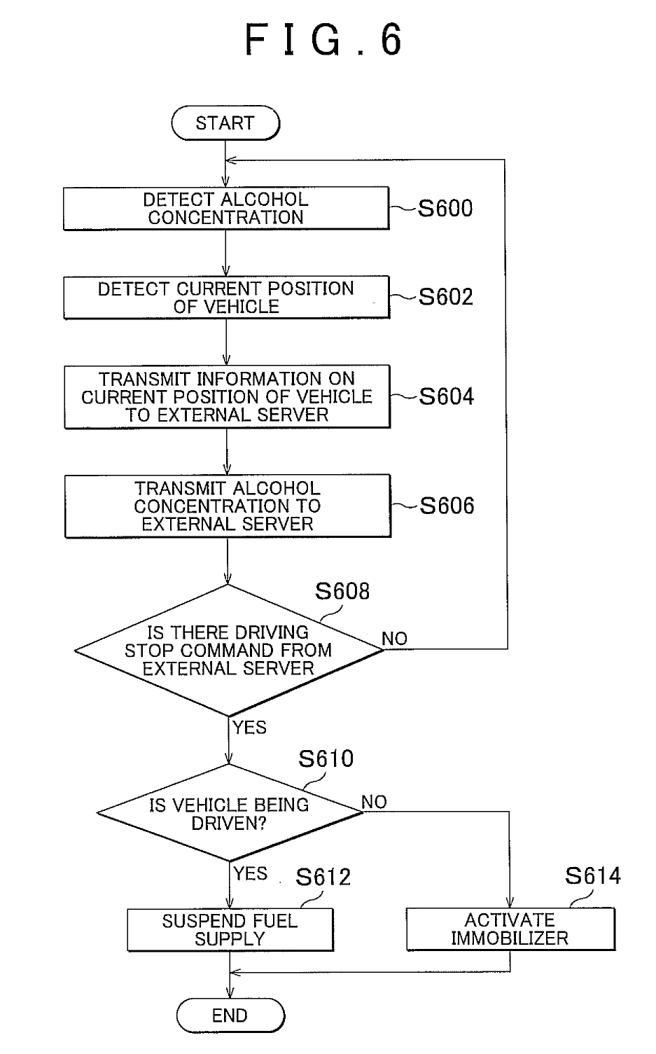

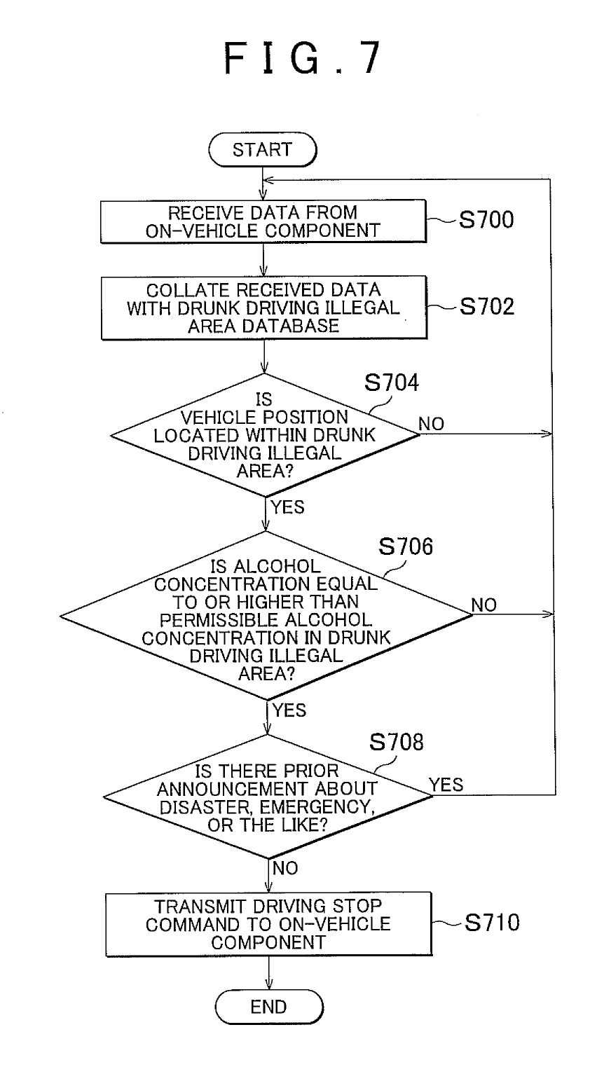

FIGS. 6 and 7 each show an example of the operation performed by the on-vehicle component 100′ and the external server 200 in the third embodiment of the invention.

FIG. 6 is a flowchart showing an example of a control routine that is executed by the on-vehicle component 100′ of this embodiment of the invention. The control routine executed by the on-vehicle component 100′ of this embodiment of the invention is different from the control routine according to the first embodiment of the invention shown in FIG. 2 in that data on the fingerprint of a driver are not detected in step 602 and that driver identification information is not transmitted to the external server 200 in step 604.

FIG. 7 is a flowchart showing an example of a control routine that is executed by the external server 200 of this embodiment of the invention.

The fourth embodiment of the invention is mainly different from the foregoing second embodiment of the invention in that the processing of reporting driver identification information is not performed. The configuration itself of the fourth embodiment of the invention may be identical to the configuration of the third embodiment of the invention (see FIG. 5). Further, the control routine executed by the external server 200 of this embodiment of the invention may be identical to the control routine according to the second embodiment of the invention shown in FIG. 4.

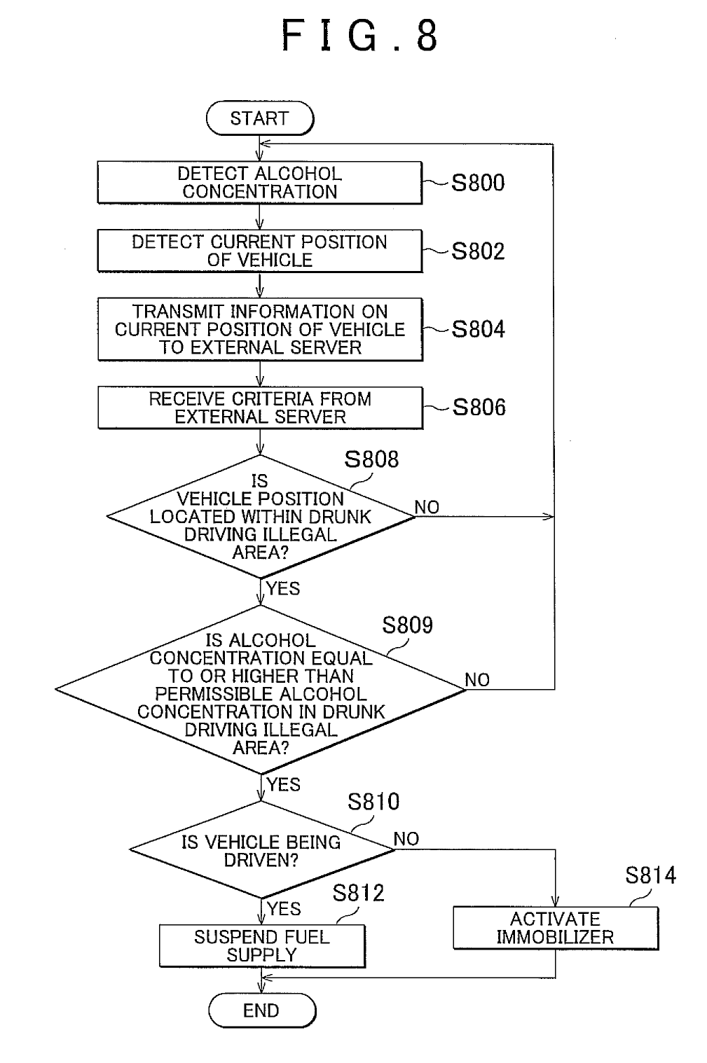

FIG. 8 is a flowchart showing an example of a control routine that is executed by the on-vehicle component 100′ of this embodiment of the invention. The control routine executed by the on-vehicle component 100′ of this embodiment of the invention is different from the control routine according to the second embodiment of the invention shown in FIG. 3 in that the reporting processing (step 316 in FIG. 3) is not performed.

The drunk driving prevention system according to each of the embodiments of the invention described above offers, above all, the following excellent effects.

As described above, by providing the storage unit 204 that stores a plurality of criteria that relate to drunk driving and are different from one another as a result of geographical differences, and changing the criteria in accordance with the vehicle position, it is possible to compensate for the geographical differences and prevent drunk driving, even in the case where the criteria relating to the alcohol concentration, which falls under drunk driving, are different from one another as a result of the geographical differences. Further, by providing the external server 200 with the storage unit 204, those criteria to be changed in accordance with changes and revisions in the decree, the ordinance, the regulations and the like can be changed/updated in a one-dimensional manner when, for example, such changes and the like are made.

Although the embodiments of the invention have been described hereinabove in detail, the invention is not limited to the foregoing embodiments thereof. The foregoing embodiments of the invention can be modified and replaced in various manners without departing from the scope of the invention.

For example, the fingerprint data are utilized as to the driver identification information in each of the foregoing embodiments of the invention, but other pieces of data on a living body (e.g., an image of a face photographed by an on-vehicle camera or the like) may be utilized.

Further, each of the foregoing embodiments of the invention relates to the vehicle that has the engine 130 as a power source, but can also be applied to a hybrid vehicle or an electric vehicle. In this case, an electric motor for driving the vehicle may be prohibited from being activated instead of or in addition to prohibiting the engine 130 from being started. Further, the drive current of the electric motor for driving the vehicle may be reduced or shut off, instead of or in addition to suspending the supply of fuel.

Further, in each of the foregoing embodiments of the invention, a report is passed to the police. However, a report may be passed to another drunk driving control organization that is substantially equivalent to the police (e.g., the military or an autonomy) or the like.

What is claimed is:

1. A drunk driving prevention system comprising:
an external server; and
an on-vehicle component, wherein
the on-vehicle component is equipped with a detection unit that detects an alcohol concentration in an exhalation of a driver of a vehicle, on which the on-vehicle component is mounted, an acquisition unit that acquires information on a current position of the vehicle, and an on-vehicle side communication unit that transmits to the external server the alcohol concentration detected as well as the information on the current position of the vehicle, and
the external server is equipped with a storage unit that stores a plurality of criteria that relate to an alcohol concentration falling under drunk driving and are different from one another as a result of geographical differences, an external server side communication unit that receives the alcohol concentration and the information on the current position of the vehicle, which are transmitted from the on-vehicle component, and a determination unit that determines, based on that one of the criteria in the storage unit which corresponds to the current position of the vehicle, whether the alcohol concentration received is the alcohol concentration falling under drunk driving.

2. The drunk driving prevention system according to claim 1, wherein
the external server is further equipped with a reporting unit that reports, when the determination unit makes an affirmative determination, the affirmative determination as well as identification information on the driver of the vehicle to a police or another drunk driving control organization.

3. The drunk driving prevention system according to claim 1, wherein
when the determination unit makes an affirmative determination, the external server transmits a driving stop command for the vehicle from the external server side communication unit to the on-vehicle component, and
the on-vehicle component is further equipped with a restraint unit that restrains driving of the vehicle from being started or continued upon receiving from the on-vehicle side communication unit a driving stop command for the vehicle from the external server.

4. The drunk driving prevention system according to claim 2, wherein
the reporting unit reports the information on the current position of the vehicle as well to the police or another drunk driving control organization.

5. The drunk driving prevention system according to claim 3, wherein
the restraint unit suspends fuel supply when an engine of the vehicle is in operation, and prohibits the engine of the vehicle from being started when the engine is out of operation.

6. A drunk driving prevention system comprising:
an external server; and
an on-vehicle component, wherein
the on-vehicle component is equipped with a detection unit that detects an alcohol concentration in an exhalation of a driver of a vehicle, on which the on-vehicle component is mounted, an acquisition unit that acquires information on a current position of the vehicle, and an on-vehicle side transmission unit that transmits to the external server the information on the current position of the vehicle,
the external server is equipped with a storage unit that stores a plurality of criteria that relate to an alcohol concentration falling under drunk driving and are different from one another as a result of geographical differences, a reception unit that receives the information on the current position of the vehicle, which is transmitted from the on-vehicle component, and an external server side transmission unit that transmits to the on-vehicle component that one of the criteria in the storage unit which corresponds to the current position of the vehicle, and
the on-vehicle component is further equipped with a determination unit that determines, based on the criterion transmitted from the external server, whether the alcohol concentration detected is the alcohol concentration falling under drunk driving.

7. The drunk driving prevention system according to claim 6, wherein
the on-vehicle component is further equipped with a reporting unit that, when the determination unit makes an affirmative determination, reports the affirmative determination as well as identification information on the driver of the vehicle to a police or another drunk driving control organization.

8. The drunk driving prevention system according to claim 6, wherein
the on-vehicle component is further equipped with a restraint unit that restrains driving of the vehicle from being started or continued when the determination unit makes an affirmative determination.

9. The drunk driving prevention system according to claim 7, wherein
the reporting unit reports the information on the current position of the vehicle as well to the police or another drunk driving control organization.

10. The drunk driving prevention system according to claim 8, wherein
the restraint unit suspends fuel supply when an engine of the vehicle is in operation, and prohibits the engine of the vehicle from being started when the engine is out of operation.

11. An external server that prevents drunk driving via communication with an on-vehicle component, comprising:
a storage unit that stores a plurality of criteria that relate to an alcohol concentration falling under drunk driving and are different from one another as a result of geographical differences;
a reception unit that receives from the on-vehicle component an alcohol concentration in an exhalation of a driver of a vehicle, on which the on-vehicle component is mounted, and information on a current position of the vehicle;
a determination unit that determines, based on that one of the criteria in the storage unit which corresponds to the current position of the vehicle, whether the alcohol concentration received is the alcohol concentration falling under drunk driving, and
a transmission unit that transmits to the on-vehicle component a driving stop command for restraining driving of the vehicle from being started or continued, when the determination unit makes an affirmative determination.

12. An external server that prevents drunk driving via communication with an on-vehicle component, comprising:
a storage unit that stores a plurality of criteria that relate to an alcohol concentration falling under drunk driving and are different from one another as a result of geographical differences;
a reception unit that receives from the on-vehicle component information on a current position of a vehicle, on which the on-vehicle component is mounted; and
a transmission unit that transmits to the on-vehicle component that one of the criteria in the storage unit which corresponds to the current position of the vehicle.
